(19) United States
(12) Patent Application Publication
(10) Pub. No.: US 2025/0162702 A1
(43) Pub. Date: May 22, 2025

(54) Method for Directly Applying Surface Texture for Improved Aerodynamics using Inkjet Printers

(71) Applicant: The Boeing Company, Arlington, VA (US)

(72) Inventors: Kjersta Lynn Larson-Smith, Seattle, WA (US); Shane Edward Arthur, Kirkland, WA (US); Edward Ryan Greene, Charleston, SC (US); Matthew H. Mellin, Seattle, WA (US)

(21) Appl. No.: 18/513,469

(22) Filed: Nov. 17, 2023

(51) Int. Cl. B64C 1/00

(52) U.S. Cl. CPC B64C 1/0009; B64C 2230/26

(57) ABSTRACT

A method for directly applying surface texture on the surface of a part to reduce drag is provided. The method comprises defining a geometry of the surface texture on the surface of the part and generating paths for inkjet printers to move over the surface of the part. The method comprises determining the number of passes and firing schedules for the inkjet printers to create the surface texture. The method comprises locating and aligning the part in a work cell. The method comprises depositing fluid droplets by the inkjet printers onto the surface to create the surface texture.

### BACKGROUND

### 1. Field

The disclosure relates generally to surface modification techniques, and more specifically to a method for directly applying surface texture using inkjet printers.

### 2. Description of the Related Art

Surface modification techniques are used to manipulate the flow of fluids (e.g., air or water) over a solid surface of an object to minimize friction and drag, ultimately improving the efficiency and performance of the object. One surface modification technique involves introducing textures or patterns to the solid surface in a way that alters the interaction between the fluid and the solid surface. By creating textures or patterns on the surface, the effective contact area between the fluid and the solid is reduced. This reduction in contact area decreases the frictional forces experienced by the object moving through the fluid. The textures or patterns on the surface disrupt the laminar flow of the fluid. This disruption effectively reduces skin friction, a significant source of drag in fluid dynamics, leading to improved aerodynamic or hydrodynamic performance.

One existing method for surface modification involves a technique known as appliqué. An appliqué is a technique in which a sheet, a fabric, or a layer with microtextures formed on it is attached or sewn onto the surface of another. By covering a solid surface with a texture or pattern, frictional forces experienced by the object moving through the fluid is reduced.

One major challenge is that most surfaces, such as aircraft wings or fuselages, are curved and not flat. Aligning these textured appliques on curved surfaces can be difficult. Achieving perfect alignment is difficult, and mismatches can result in wrinkles or misalignments on the surface, which can negatively impact the intended aerodynamic or hydrodynamic performance improvements. The appliques must be precisely sized to match the contours of the curved surface. If the sizing is even slightly off, it can result in overlaps, gaps, or distortions in the applied texture, reducing the effectiveness of the surface modification.

### SUMMARY

An illustrative embodiment provides a method for directly applying surface texture on the surface of a part to reduce drag. The method comprises defining a geometry of the surface texture on the surface of the part and generating paths for inkjet printers to move over the surface of the part. The method comprises determining the number of passes and firing schedules for the inkjet printers to create the surface texture. The method comprises locating and aligning the part in a work cell. The method comprises depositing fluid droplets by the inkjet printers onto the surface to create the surface texture.

In an illustrative embodiment, the surface texture comprises a plurality of riblets formed on the surface. The surface texture can be formed by controlling the size of the fluid droplets. The size of the fluid droplets can be varied to successively smaller droplets to form a textured pattern of riblets on the surface.

In an illustrative embodiment, the inkjet printer comprises a piezoelectric actuator in contact with fluid. The piezoelectric actuator is configured to change shape in response to an electrical pulse applied to the piezoelectric actuator, thereby generating a pressure wave in the fluid, and forcing a controlled amount of fluid out of the inkjet printer as the fluid droplets.

In an illustrative embodiment, the method comprises adjusting the size of the fluid droplets by varying the magnitude and pulse width of the electrical pulse.

In an illustrative embodiment, the method comprises curing the fluid droplets, thereby causing materials in the fluid droplets to polymerize and bond with the surface.

Another illustrative embodiment provides a method for creating riblets on the surface of a part to reduce drag. The method comprises defining the geometry of the riblets on the surface of the part and generating paths for inkjet printers to move over the surface of the part. The method comprises determining the number of passes and firing schedules for the inkjet printers to create the riblets. The method comprises locating and aligning the part in a work cell and depositing fluid droplets by the inkjet printers onto the surface to create the riblets.

Another illustrative embodiment provides a method for directly applying surface texture on the surface of a part to reduce drag. The method comprises defining a geometry of the surface texture on the surface of the part and generating paths for inkjet printers to move over the surface of the part. The method comprises determining the number of passes and firing schedules for the inkjet printers to create the surface texture. The method comprises locating and aligning the part in a work cell. The method comprises adjusting the size of the fluid droplets in response to input data related to the geometry of the surface texture. The method comprises firing the fluid droplets to selectively position the fluid droplets on the surface to achieve a desired texture pattern. The method comprises controlling the movement of the inkjet printers relative to the surface to vary the thickness of the surface texture.

### BRIEF DESCRIPTION OF THE DRAWINGS

The novel features believed characteristics of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a system in accordance with an illustrative embodiment;

FIGS. 2A and 2B illustrate fluid droplets to achieve a desired texture;

FIG. 3 illustrates a technique for creating a desired texture;

FIGS. 4A, 4B and 4C illustrate perspective views of example riblets formed on a surface;

FIGS. 5A and 5B illustrate varying the height and width of a surface texture by varying the velocity of an inkjet printer; and

FIG. 6 depicts a flowchart illustrating a method of directly applying a surface texture on a surface.

### DETAILED DESCRIPTION

The illustrative embodiments recognize and take into account one or more different considerations. For example, the illustrative embodiments recognize and take into account that most surfaces, such as aircraft wings or fuselages, are curved and not flat. As such, aligning textured appliques on curved surfaces can be difficult. The illustrative embodiments recognize and take into account that achieving perfect alignment on curved surfaces is difficult, and mismatches can result in wrinkles or misalignments on the surface, which can negatively impact the intended aerodynamic or hydrodynamic performance improvements. The illustrative embodiments recognize and take into account that appliqués must be precisely sized to match the contours of the curved surface. If the sizing is even slightly off, it can result in overlaps, gaps, or distortions in the applied texture, reducing the effectiveness of the surface modification.

The illustrative embodiments provide a method and a system for applying surface texture on a solid surface using inkjet printing. In contrast to conventional methods that rely on appliqué techniques, the illustrative embodiments provide direct surface texturing through inkjet printing. The illustrative embodiments offer greater precision and control over the texture application process, especially on complex, curved surfaces.

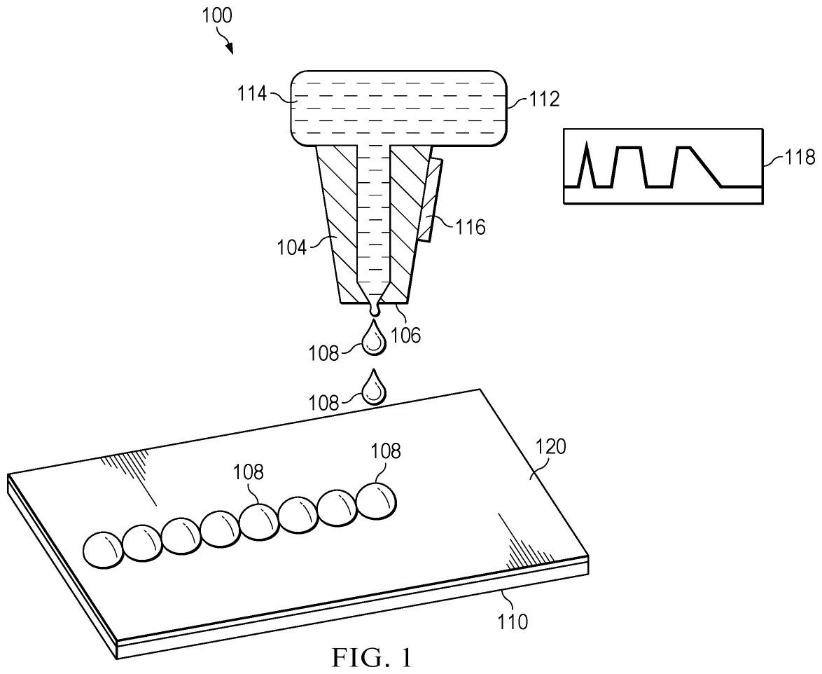

FIG. 1 depicts system 100 in accordance with an illustrative embodiment. System 100 utilizes an inkjet printer to directly apply a surface texture to a solid surface, thus modifying the surface. The surface modification technique of applying a texture is also known as micro-texturing. The purpose of surface modification by applying a texture is to reduce resistance or skin friction by manipulating the flow of fluids, such as air or water, as it moves over a solid surface. By introducing surface textures, the effective contact area between the fluid and the solid surface is reduced, which in turn reduces friction. This reduction in friction leads to reduced drag which improves aerodynamic or hydrodynamic performance of an object.

System 100 can be used to apply surface textures to a variety of solid surfaces. For example, system 100 can be used to apply surface textures directly on the surface of a wing or a fuselage of an aircraft. Also, system 100 can be used to apply surface textures directly to the hull of a ship.

With reference to FIG. 1, system 100 includes inkjet printer 104 with at least one nozzle 106 for ejecting fluid droplets 108 of a selected material on substrate 110. Although, in FIG. 1, inkjet printer 104 is shown as having a single nozzle 106, inkjet printer 104 may include many (e.g., hundreds or thousands) of nozzles.

Inkjet printer 104 includes fluid reservoir 112 which stores fluid 114. Fluid may comprise an ink, a resin dissolved in a solvent, or any other suitable material. Inkjet printer 104 includes an actuator 116 which may be positioned behind nozzle 106. Actuator 116 can be in contact with fluid 114. In response to driving signal 118, actuator 116 changes shape which generates a pressure wave in fluid 114. The effect of this pressure wave is that a controlled amount of fluid is forced out as fluid droplets 108 out of nozzle 106.

In an illustrative embodiment, actuator 116 is a piezoelectric actuator configured to change shape in response to an electrical pulse (e.g., driving signal 118) applied to actuator 116. By varying the magnitude and pulse width of the electrical pulse, the size of fluid droplets 108 can be adjusted. In other example embodiments, inkjet printer 104 can be a thermal printer or a mechanical printer.

In an illustrative embodiment, substrate 110 may, for example, be a section of an aircraft such as a wing, a fuselage, or a vertical fin. In other embodiments, substrate 110 may be a hull of a ship or a boat.

In an illustrative embodiment, fluid droplets 108 are deposited on substrate 110 to modify solid surface 120 by forming a texture or a pattern on solid surface 120. The purpose of surface modification by applying a texture or a pattern is to reduce resistance or skin friction by manipulating the flow of fluids, such as air or water, as it moves over solid surface 120.

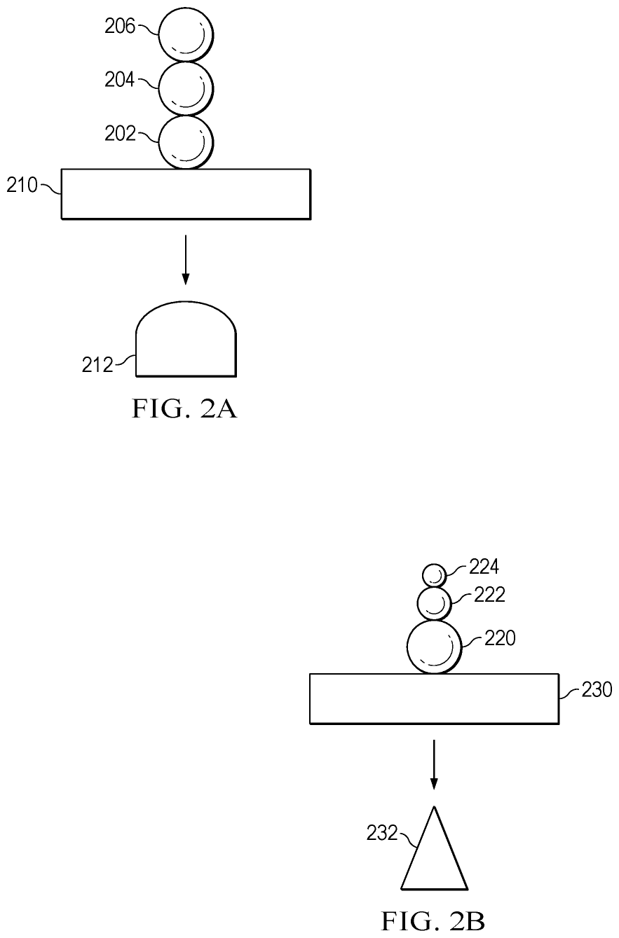

In an illustrative embodiment, the size of the fluid droplets is controlled to achieve a desired texture or a pattern on a substrate. In FIG. 2A, droplets 202, 204 and 206, which have the same size, are deposited on substrate 210. Fluid droplet 202 is first deposited, and next fluid droplet 204 is deposited on fluid droplet 202. The process is repeated until fluid droplet 206 is deposited on fluid droplet 204, thus building up fluid droplets one on top of the other. The effect of this is that the resulting texture 212 has a mound-shaped profile. In FIG. 2B, fluid droplets 220, 222 and 224, which have successively smaller size, are deposited on substrate 230. The effect of this is that the resulting texture 232 has a riblet-shaped profile.

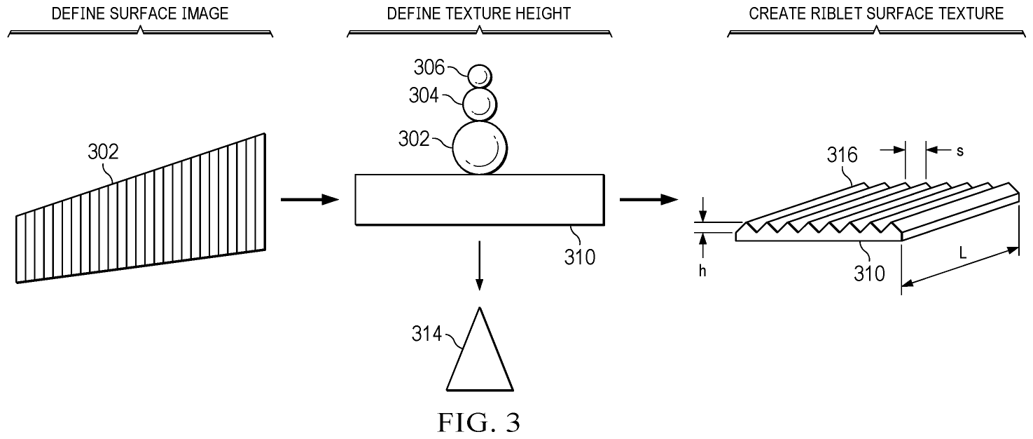

FIG. 3 illustrates how a desired textured surface on a substrate is created. The process involves depositing material in a layer-by-layer fashion to create a desired textured surface. In an illustrative embodiment, a textured surface comprising riblets is created through inkjet-based manufacturing. Riblets are small, parallel, and regularly spaced ridges or grooves that are molded or etched onto the surface of a substrate. The riblets can vary in size and spacing depending on the desired effect. The riblets are typically oriented in the direction of the desired fluid flow, such as the direction of airflow over an aircraft wing or water flow over a ship's hull.

With reference to FIG. 3, a two-dimensional model such as image 302 which defines the geometry of the riblets on a surface is generated. The geometry may define the height, spacing and other attributes of the riblets. A computer-aided-design (CAD) software, for example, can be used to define the geometry.

In an illustrative embodiment, a software program interprets the two-dimensional model (e.g., image 302) and generates a series of instructions including the size of fluid droplets 304, 306 and 308 to create the riblet structure on surface 310. Inkjet printer 104 (not shown in FIG. 3) follows the instructions to deposit fluid droplets one over another to create the riblet structure on surface 310. In FIG. 3, fluid droplets 304, 306 and 308 have successively smaller sizes. Thus, fluid droplet 304 is smaller than fluid droplet 302, and fluid droplet 306 is smaller than fluid droplet 304. Fluid droplets 304, 306 and 308 are built one on top of another by repeating the process. By depositing successively smaller fluid droplets, riblet 314 acquires a triangular-shaped profile.

To create a textured surface on the entire surface 310, the software program calculates the optimal velocity at which to move inkjet printer 104 during the deposition process. The velocity may be adjusted based on factors like the fluid droplet's viscosity and the height of the desired texture. Initially, inkjet printer 104 moves to a starting position. Then, it ejects fluid droplets of material according to the predetermined pattern. The velocity of the inkjet printer is controlled, and the process is repeated until small, parallel, and regularly spaced riblets 316 are molded on surface 310.

In an illustrative embodiment, after the deposition, the fluid droplets are cured, thus allowing the material in the fluid droplets to polymerize and bond with the surface. The material may include ink, resin, or any other suitable material.

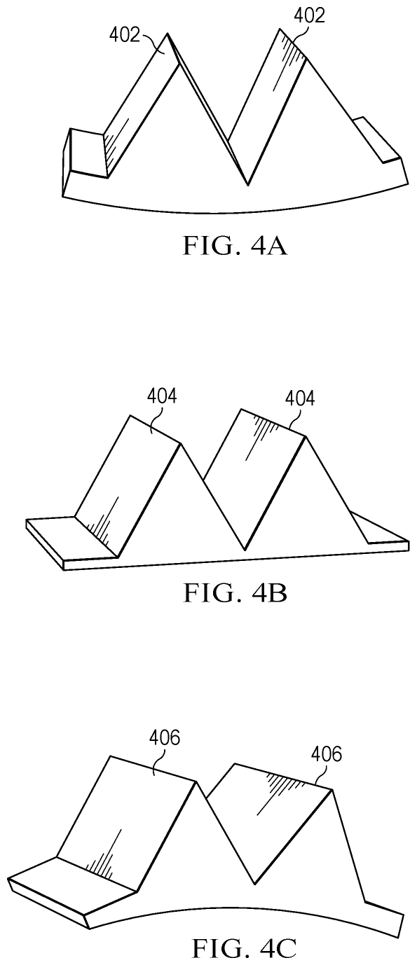

FIGS. 4A, 4B and 4C illustrate perspective views of example riblets formed on a surface in accordance with illustrative embodiments. In FIG. 4A, riblets 402 have a peak-to-peak spacing of 9.3283 mm, in FIG. 4B, riblets 404 have a peak-to-peak spacing of 10.0 mm, and in FIG. 4C, riblets 406 have a peak-to-peak spacing of 11.7859 mm. Depending on the surface onto which the riblets are created, the drag reduction performance of the riblets varies depending on the peak-to-peak spacing of the riblets. In an example embodiment, a laser scanner or a stereoscopic camera can be used to scan, for example, a vertical fin or a wing of an aircraft and generate images. A software program interprets the images and computes the optimal geometry and placement of the riblets to be formed on the surface of a part in order to maintain desired peak-to-peak spacing. In an example embodiment, a wing, or a vertical fin of an aircraft, for example, is scanned and a software program computes the geometry of the riblets based on the scanned images to maintain a desired peak-to-peak spacing (e.g., 10 mm) to achieve desired aerodynamic results.

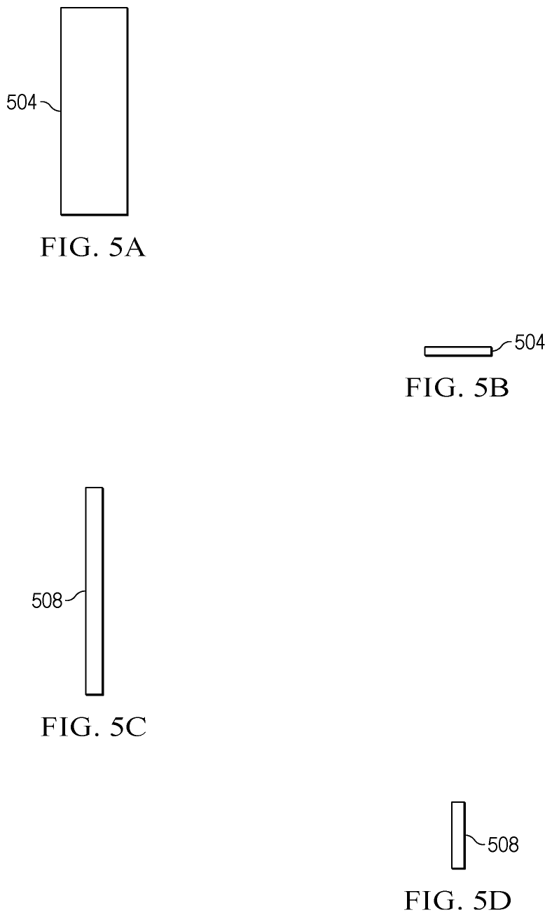

In illustrative embodiments, the height, and the width of texture features (e.g., riblets) formed in each pass on a surface are varied by adjusting the speed of an inkjet printer relative to the surface. Slower speed yields taller texture features while faster speed yields shorter texture features. In FIGS. 5A and 5B, an inkjet printer (not shown in FIGS. 5A and 5B) moves at a speed of 6 in/sec over a surface in a single pass. FIG. 5A illustrates a top view of a resulting texture 504 which has width of 0.18 inches, and FIG. 5B illustrates a cross-sectional view of texture 504 which has a height of 10 micron.

In FIGS. 5C and 5D, the inkjet printer moves at a speed of 1 in/sec over the surface in a single pass. FIG. 5C illustrates a top view of a resulting texture 508 which has width of 0.03 inches, and FIG. 5D illustrates a cross-sectional view of texture 508 which has a height of 60 micron.

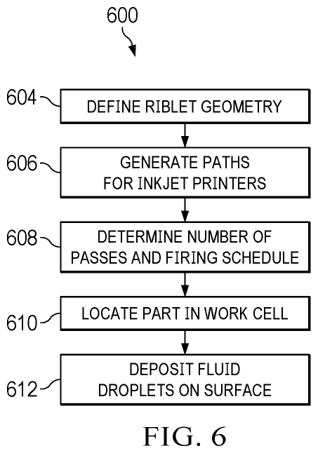

FIG. 6 depicts flowchart 600 of a method of directly applying a surface texture on a surface in accordance with the illustrative embodiments. In an illustrative embodiment, the surface texture comprises riblets which are created through inkjet-based manufacturing. Riblets are small, parallel, and regularly spaced ridges or grooves that are molded or etched onto a surface. The riblets can vary in size and spacing depending on the desired effect. The riblets are typically oriented in the direction of the desired fluid flow, such as the direction of airflow over an aircraft wing or water flow over a ship's hull.

Process 600 starts with defining a riblet geometry of the surface of a part (step 604). The part, for example, may be a wing or a fuselage segment of an aircraft that requires riblet application. A computer-aided-design (CAD) software, for example, can be used to define the geometry.

In an example embodiment, a software program interprets the geometry and generates paths for inkjet printers to move over the part to cover a desired area for riblet application (step 606). The software program may generate paths or grid which is optimized to achieve the specific riblet pattern on the surface of the part and to ensure complete coverage of the surface. The inkjet printers may be held or retained by an automation system which may include one or more robots that precisely control the movement of the inkjet printers. This controlled motion ensures even and consistent riblet application across the entire surface.

Based on the size and shape of the riblets, the number of passes required to achieve the desired geometry and nozzle firing schedules are determined by the software program (step 608). For example, for a given fluid material if a print head of an inkjet printer puts down or deposits 10 um per pass and needs to create a 30 um tall riblet with a triangular profile, the desired riblet can be created in three passes with smaller fluid droplets used on each successive pass. This process is illustrated in FIG. 2B where fluid droplets 220, 222 and 224, which have successively smaller size, are deposited on a surface to create a riblet.

The part is then located in a work cell relative to the inkjet printers (step 610). In an example embodiment, the part can be aligned with the inkjet printers using a laser tracker alignment system or a robot-mounted vision system. With the part in place and inkjet printers ready, the riblet deposition process begins (step 612). The inkjet printers deposit fluid droplets directly onto the surface of the part. These droplets create the desired riblet pattern, which reduces aerodynamic drag.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combination of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for directly applying surface texture on the surface of a part to reduce drag, comprising:
defining a geometry of the surface texture on the surface of the part;
generating paths for inkjet printers to move over the surface of the part;
determining the number of passes and firing schedules for the inkjet printers to create the surface texture;
locating and aligning the part in a work cell; and
depositing fluid droplets by the inkjet printers onto the surface to create the surface texture.

2. The method of claim 1, wherein the surface texture comprises a plurality of riblets formed on the surface.

3. The method of claim 1, wherein the surface texture is formed by controlling the size of the fluid droplets.

4. The method of claim 1, further comprising:
varying the size of the fluid droplets to successively smaller droplets; and
forming a textured pattern of riblets on the surface.

5. The method of claim 1, wherein the inkjet printer comprises a piezoelectric actuator in contact with fluid, and wherein the piezoelectric actuator is configured to change shape in response to an electrical pulse applied to the piezoelectric actuator, thereby generating a pressure wave in the fluid and forcing a controlled amount of fluid out of the inkjet printer as the fluid droplets.

6. The method of claim 5, further comprising adjusting the size of the fluid droplets by varying the magnitude and pulse width of the electrical pulse.

7. The method of claim 1, further comprising curing the fluid droplets, thereby causing materials in the fluid droplets to polymerize and bond with the surface.

8. The method of claim 1, wherein the fluid comprises resin dissolved in a solvent.

9. The method of claim 1, further comprising controlling the movement of the inkjet printer relative to the surface to vary the thickness of the surface texture.

10. The method of claim 9, wherein the velocity of the inkjet printer is varied to control the thickness of the surface texture.

11. A method for creating riblets on the surface of a part to reduce drag, comprising:
defining a geometry of the riblets on the surface of the part;
generating paths for inkjet printers to move over the surface of the part;
determining the number of passes and firing schedules for the inkjet printers to create the riblets;
locating and aligning the part in a work cell; and
depositing fluid droplets by the inkjet printers onto the surface to create the riblets.

12. The method of claim 11, wherein the inkjet printer comprises a piezoelectric actuator in contact with fluid, and wherein the piezoelectric actuator is configured to change shape in response to an electrical pulse applied to the piezoelectric actuator, thereby generating a pressure wave in the fluid and forcing a controlled amount of fluid as the fluid droplets out of the inkjet printer.

13. The method of claim 12, further comprising adjusting the size of the fluid droplets by varying the magnitude and time period of the electrical pulse.

14. The method of claim 11, further comprising:
varying the size of the fluid droplets to successively smaller droplets; and
creating the riblets on the surface.

15. The method of claim 11, further comprising controlling the movement of the inkjet printer relative to the surface to vary the thickness of the riblets.

16. The method of claim 15, wherein the velocity of the inkjet printer is varied to control the thickness of the riblets.

17. A method for applying surface texture on the surface of a part to reduce drag, comprising:
defining a geometry of the surface texture on the surface of the part;
generating paths for inkjet printers to move over the surface of the part;
determining the number of passes and firing schedules for the inkjet printers to create the surface texture;
locating and aligning the part in a work cell;
adjusting the size of the fluid droplets in response to input data related to the geometry of the surface texture;
firing the fluid droplets to selectively position the fluid droplets on the surface to achieve a desired texture pattern; and
controlling the movement of the inkjet printers relative to the surface to vary the thickness of the surface texture.

18. The method of claim 17, wherein the surface texture comprises a plurality of riblets.

19. The method of claim 17, further comprising:
varying the size of the fluid droplets to successively smaller droplets; and
forming a textured pattern of riblets on the surface.

20. The method of claim 17, further comprising curing the fluid droplets to harden and bond with the surface.

21. The method of claim 17, wherein the fluid droplets comprise an ink or a coating material.
